(19) United States
(12) Patent Application Publication
(10) Pub. No.: US 2013/0200245 A1
(43) Pub. Date: Aug. 8, 2013

(54) SOLAR PANEL CLAMP

(71) Applicants: John B. Markiewicz, Mentor, OH (US); Darius J. Kaunas, Medina, OH (US)

(72) Inventors: John B. Markiewicz, Mentor, OH (US); Darius J. Kaunas, Medina, OH (US)

(73) Assignee: Preformed Line Products, Mayfield Village, OH (US)

(21) Appl. No.: 13/368,651

(22) Filed: Feb. 8, 2012

(51) Int. Cl. F16B 35/00; B23P 11/00; B23P 17/00

(52) U.S. Cl. 248/500; 29/525.11; 29/525.08

(57) ABSTRACT

Among other things, one or more clamping apparatuses for securing a photovoltaic module to a rail are described. The clamping apparatus comprises, among other things, a spacer that is configured to cause a space of a specified distance to be created between a clamp of the clamping apparatus and a rail to which the photovoltaic module is secured. In this way, the clamping apparatus may be attached to the rail prior to the module being positioned relative to the rail. Moreover, one or more methods are described for preassembling a rail that comprises clamping apparatuses and/or for preassembling a clamping apparatus. Such preassembly of the clamping apparatus may reduce installation time and reduce total cost associated with photovoltaic arrays.

### BACKGROUND

The present application relates to, among other things, systems and/or methods for clamping photovoltaic (PV) modules to a rail and/or rail system configured to support the photovoltaic modules (e.g., to form a PV array).

Solar power often refers to the conversion of energy from sunlight to electricity (e.g., to power an appliance, car, home, business, etc.). Solar power generation has become increasingly popular given a shift away from producing electricity via fossil fuels (e.g., coal, oil, natural gas, etc.). Such an increase in popularity may be attributed to numerous factors. For example, the production of electricity via sunlight is considered to be more environmentally friendly than using fossil fuels (e.g., few to no pollutants are emitted using solar technology). Moreover, the conversion efficiency (e.g., amount of sunlight converted into electricity) has continued to increase while the cost to manufacture photovoltaic modules (e.g., solar panels) has decreased, allowing for more widespread applicability (e.g., both in terms of geographic location and affordability).

To convert sunlight or other light into electricity, one or more photovoltaic modules, comprised of a plurality of photovoltaic cells, may be used. Respective photovoltaic cells are configured to convert light energy (e.g., from the sun) into electricity via the photovoltaic effect (e.g., where a voltage and/or electric current is created in a material based upon exposure to light). Because the power that one module can produce is usually insufficient to meet a desired power output (e.g., to power a home and/or business), a plurality of photovoltaic modules may be operably coupled together and arranged to form a photovoltaic array. Traditionally, the photovoltaic modules have been arranged in a grid of rows or columns. However, in some applications, they may be arranged in a different pattern.

To secure the photovoltaic modules, a traditional rail and top-down clamping apparatus have been employed. The rails often comprise a channel and the clamping apparatus comprises a t-shaped bolt (e.g., also referred to as a “t-bolt”) that is designed to fit into the channel of the rail. In operation, the t-bolt is usually inserted into the channel and turned to a desired orientation relative the channel. A clamp of the clamping apparatus is then attached to the t-bolt and secured via a nut to mitigate movement of the module relative to the rail.

Typically, components of the clamping apparatus (e.g., the t-bolt, clamp, and nut) are shipped individually to the installation site and assembled once the modules have been set in place. That is, the module is set in place, the t-bolt is inserted into the channel, the clamp is attached to the bolt, the nut is attached to the bolt, and then the nut is tightened to secure the module (e.g., via the clamp). Given that a typical photovoltaic array comprises at least 12 modules, and may exceed 100 modules, and given that a plurality of clamping apparatuses may be used to secure respective modules, the installation process may be labor intensive (e.g., adding to the total cost of the photovoltaic array). Moreover, given that clamping apparatuses are assembled on site, bolts, clamps and/or nuts may be lost, dropped, etc. during the installation process, further increasing installation time and/or cost.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, a clamping apparatus is provided that is configured to address and/or mitigate at least some of the aforementioned issues. The clamping apparatus comprises a spacer (e.g., comprised of a compressible material) that is inserted between a head of a bolt (e.g., the t-shaped portion of a t-bolt) and a clamp for securing a photovoltaic module. The spacer is configured to cause a space of a specified length to be created between the head of the bolt and the clamp. Generally, this space is sufficient to accommodate a photovoltaic (PV) module (e.g., PV module can be slide between the head of the bolt (e.g., or a rail into which a head of the bolt is inserted) and the clamp). A nut of the clamping apparatus can then be tightened to secure the photovoltaic module (e.g., causing the spacer to be compressed and the space between the head of the bolt and the clamp to be reduced). Importantly, the spacer allows the clamping apparatus to be preassemble and shipped to the job site in a preassembled configuration and installed in the preassembled configuration, such that an installer merely has to insert the preassembled configuration into a rail and tighten the nut to secure a PV module via the clamp. In this manner, fewer parts may be lost and installation time and cost may be reduced.

One or more methods are also provided for attaching a clamping apparatus to a rail, or a channel within the rail. By way of example, a method for preassembling a clamping apparatus prior to insertion of a t-bolt into the channel may be devised (e.g., whereas a conventional clamping apparatus has been assembled piece-by-piece after the t-bolt is inserted into the channel). As such, the clamping apparatus may be preassembled at the installation site and/or assembled at a factory and shipped to the installation site preassembled (e.g., reducing installation cost). Moreover, in another example method, the clamping apparatus may be attached to the rail prior to positioning the module relative to the rail. As an example, installers may insert the clamping apparatuses into the rails (e.g., prior to installing the rails on a roof) and/or the rails may be shipped to the installation site with clamping apparatuses already attached to the rails (e.g., further reducing installation cost). It will be appreciated that such preassembling may occur because the spacer can be configured to maintain a relative position between a head of a bolt and a clamp (e.g., secured to the bolt via a nut).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### FIGURES

The application is illustrated by way of example and not limitation in the figures of the accompanying drawings, in which like references generally indicate similar elements and in which:

FIG. 1 illustrates an example of a photovoltaic array.

FIG. 2 illustrates a cross-sectional view of an example photovoltaic array comprising rails to which one or more photovoltaic modules can be attached.

FIG. 3 illustrates an example clamping apparatus.

FIG. 4 illustrates a top-down view of an example bolt of an example clamping apparatus.

FIG. 5 illustrates a top-down view of an example clamp of an example clamping apparatus.

FIG. 6 illustrates a cross-sectional view of an example photovoltaic array with a clamping apparatus attached thereto.

FIG. 7 illustrates a cross-sectional view of an example photovoltaic array with a clamping apparatus being inserted into a channel of a rail of the array.

FIG. 8 illustrates a clamping apparatus being rotated to lock the clamping apparatus into a channel of a rail of a photovoltaic array.

FIG. 9 illustrates an example flow diagram of an example method for preassembling a rail of a photovoltaic array.

FIG. 10 illustrates an example flow diagram of an example method for securing a photovoltaic module to a rail.

### DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing subject matter.

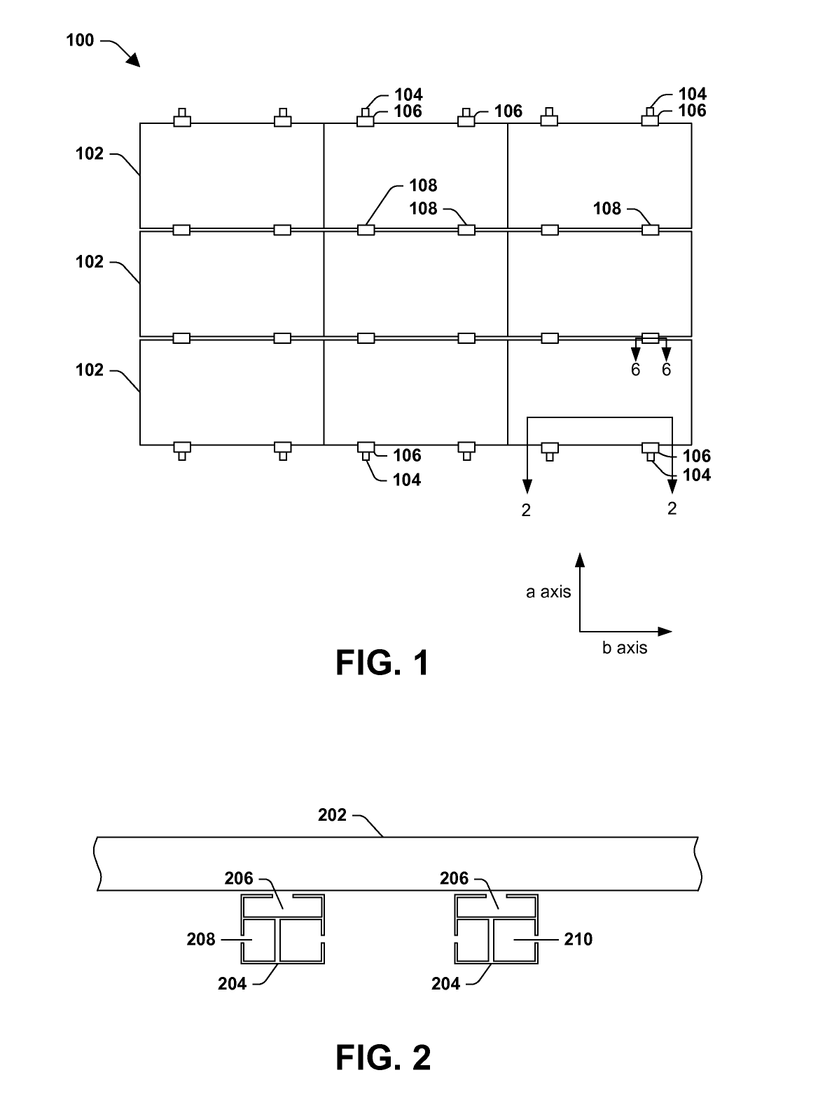

FIG. 1 illustrates an example photovoltaic array 100 (e.g., also referred to as a solar panel array, solar array, and/or the like) comprised of a plurality of photovoltaic modules 102 that are arranged along and/or attached to one or more rails 104 (e.g., substantially occluded by the overlying modules 102). As illustrated herein, the rails 104 extend substantially parallel to the a-axis, although they may extend substantially parallel to the b-axis. Moreover, as will be described in further detail with respect to FIG. 2, respective rails further comprise a channel that runs along the length of the rails (e.g., in the example embodiment, channels run parallel to the a-axis).

Channels in the rails may be useful for securing the modules 102 to the rails 104 via one or more clamping apparatuses 106, 108. For example, in the illustrated embodiment, the modules 102 are secured to the rails 104 via end-clamp apparatuses 106 and mid-clamp apparatuses 108. Generally, the differences between end-clamp apparatuses 106 and mid-clamp apparatuses 108 are merely based upon the number of modules the clamping apparatus is intended to secure and/or the location of the clamping apparatus. For example, in the illustrated embodiment, end-clamp apparatuses 106 are positioned on an edge of the array 100 and are respectively configured to secure merely one module 102. Mid-clamp apparatuses 108 are positioned between modules 102 of the array 100 and are configured to secure two or more modules 102, for example. As used herein, the terms clamping apparatus, clamping apparatuses, and/or the like are intended to be interpreted in a broad sense to comprise both end-clamp apparatuses 106 and mid-clamp apparatuses 108.

While a specific rail type and/or structure configuration is shown in the examples described herein, it is to be understood that the clamping apparatus(es) described herein can be employed with alternative rail and/or attachments systems to the extent practical. Moreover, the number of modules comprised in the example array 100, the arrangement of the array 100, and/or the arrangement of the modules 102 relative to the rails 104 are not intended to limit the scope of the appended claims. Further, while specific reference is made to the applicability of the clamping apparatus for securing photovoltaic modules, it will be appreciated that the clamping apparatus(es) may find utility in other applications. Thus, to the extent practical, the instant disclosure, including the scope of the claims, is not intended to be limited to a clamping apparatus for securing photovoltaic modules.

FIG. 2 illustrates a cross-sectional view of a photovoltaic array (e.g., 100 in FIG. 1) (e.g., taken along line 2-2 in FIG. 1). As illustrated, a photovoltaic module 202 (e.g., 102 in FIG. 1) is situated on top of one or more rails 204 (e.g., 104 in FIG. 1). The rails 204 are configured to accommodate a clamping apparatus (not shown) to secure the module 202 to the rail 204. For example, in the illustrated embodiment, respective rails 204 comprise a channel 206 through which a portion of the clamping apparatus (e.g., a t-shaped or other-shaped head of the clamping apparatus (e.g., or, more particularly, of a bolt portion of the clamping apparatus)) may be inserted. However, other mechanisms for securing the clamping apparatus to the rail are also contemplated. For example, in another embodiment, the rail comprises an extruded portion to which the clamping apparatus attaches.

It will be appreciated that one or more of the rails 204 may further comprise other channels 208, 210 that may be utilized to secure the rail to other rails and/or to secure the rail to a supporting structure (e.g., such as a roof or pole to which the photovoltaic array is attached), for example. Moreover, the shape of the rail, number and/or size of additional channels, etc. may depend upon, among other things, how the rails 204 are coupled together (e.g., if they are coupled together), a weight of the modules 202, a structure to which the rails 204 attach, etc.

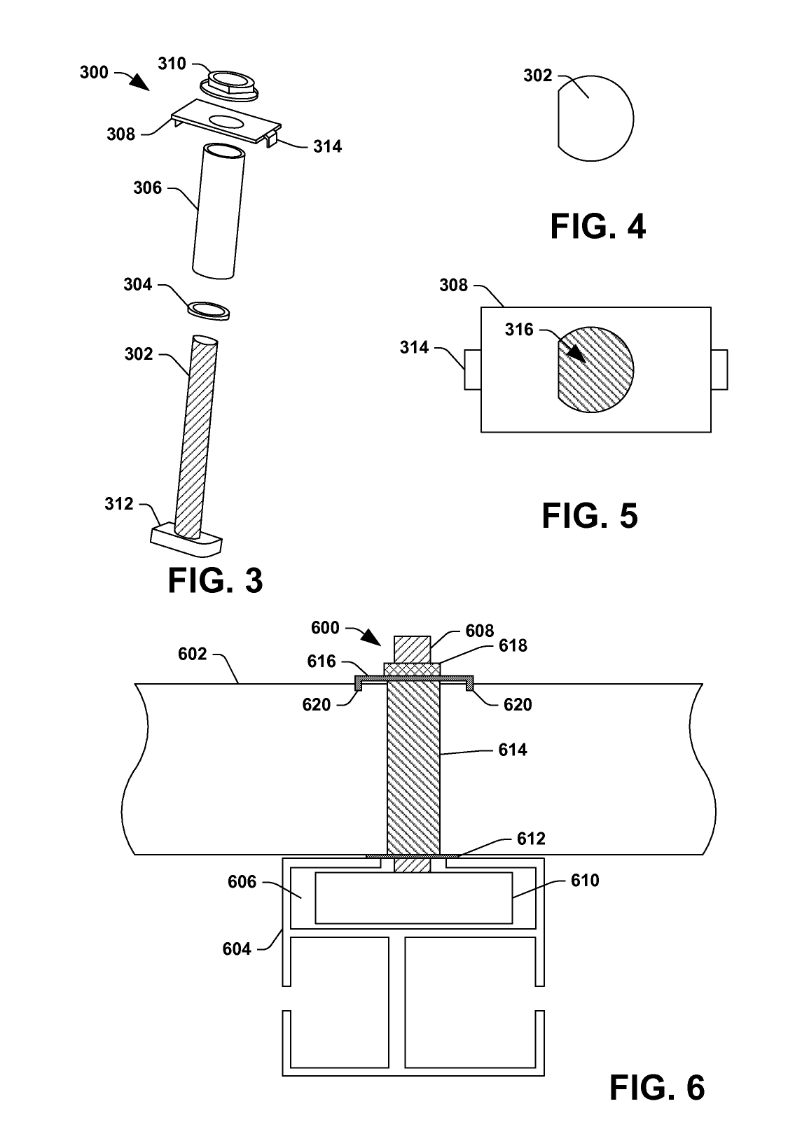

FIG. 3 illustrates an exploded view of a clamping apparatus 300 (e.g., 106, 108 in FIG. 1) that may be configured to secure one or more photovoltaic modules (e.g., 202 in FIG. 2) to a rail(s) (e.g., 204 in FIG. 2). It will be appreciated that FIG. 3 illustrates what is referred to above as a mid-clamp apparatus (e.g., based upon the size and/or shape of the clamp 308), although the features described herein may also be applicable to end-clamp apparatuses.

The clamping apparatus 300 comprises a threaded bolt 302, a grounding clip 304, a spacer 306, a clamp 308, and a nut 310. It will be appreciated that at least some of these components may be optional and/or the clamping apparatus 300 may comprise additional components not described herein. For example, in one embodiment, the grounding clip 304 (e.g., washer) may be optional.

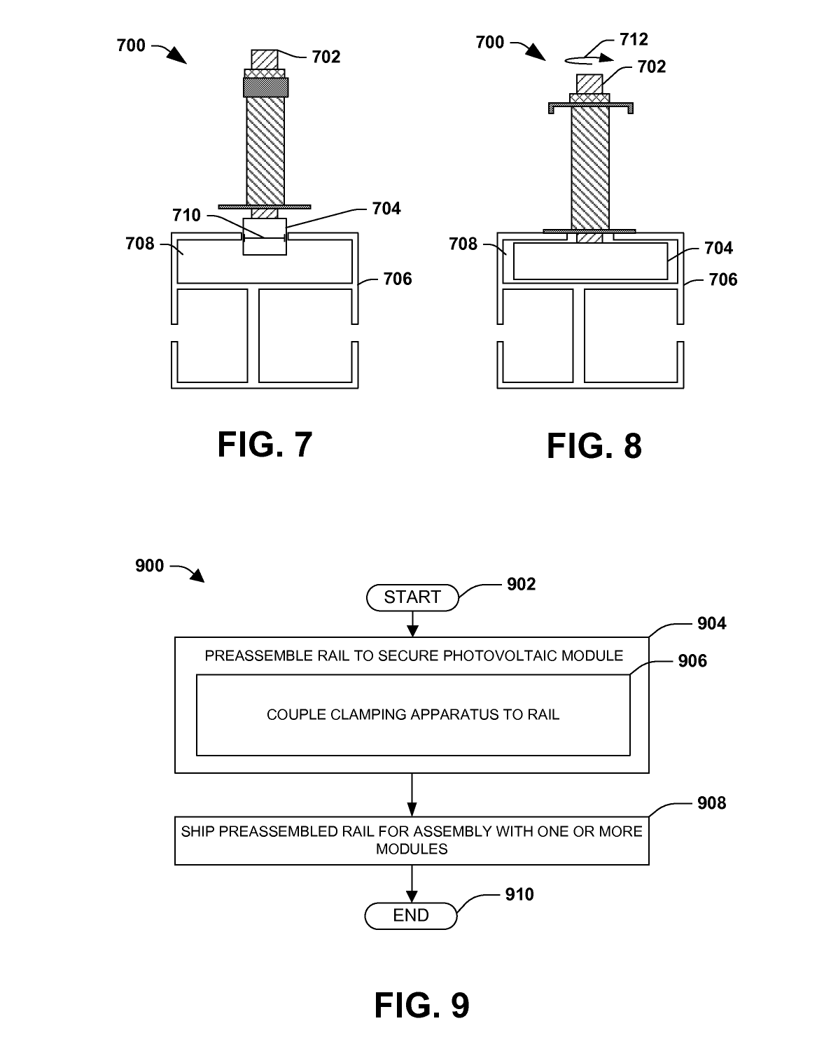

The threaded bolt 302 may comprise at least two ends (e.g., a first end and a second end), where one end may be defined by a head 312 that is configured to be inserted into a channel of a rail, for example. Typically, the head 312 has at least one dimension that is greater than a width of the channel, which reduces the possibility of the bolt 302 coming out of the channel once the head 312 is inserted into the channel and/or oriented as desired relative to the channel. By way of example, in the illustrated clamping apparatus 300, the bolt 302 comprises a T-shaped portion or T-shaped head 312. As will be further understood in view of FIGS. 7-8, such a bolt 302 is configured to (easily) slip into the channel of the rail when it is oriented in a first manner relative to the channel (e.g., when the more narrow dimension of the head 312 is perpendicular to the length of the channel) and to be secured in the channel when it is oriented in a second manner relative to the channel (e.g., when the more narrow dimension of the head 312 is parallel to the length of the channel).

Alternatively, in another embodiment, the threaded bolt 302 may not comprise a defined head 312. Rather, a nut and/or other component may be coupled to the bolt 302 to substantially form a head that has at least one dimension that is greater than a width of the channel, for example.

The example clamping apparatus 300 also comprises a grounding clip 304. The grounding clip may be selectively coupled to a shaft of the bolt 302 and/or may be permanently affixed the bolt 302. For example, in one embodiment, the grounding clip 304 may comprise a washer with smooth and/or jagged surfaces. By way of example, the washer may comprises one or more teeth that are configured to mitigate rotation of the washer relative to the rail and/or are configured to pierce into the rail (e.g., comprised of an anodized aluminum) to provide a gas tight connection between the washer and the rail, for example (e.g., mitigating oxidation). It will be appreciated that by coupling the rail to the grounding clip 304 as described, the clamping apparatus 300 and/or the photovoltaic module to which it is affixed may be ground to the rail. In this way, a ground wire may not be run to respective clamping apparatuses and/or to respective photovoltaic modules, for example.

In another embodiment, the grounding clip 304 may be configured to attach to a ground wire that is coupled to ground wires from other clamping apparatuses and/or coupled to an earthing electrode (e.g., metal rod), for example. Such a feature may reduce undesired contact with a voltage should electrical components of the array fail, reduce build-up of electricity, and/or provide a channel for conducting high currents associated with lightning strikes, for example.

It will be appreciated that the illustrated grounding clip 304 (e.g., which has a shape similar to a washer) is merely one of numerous examples of grounding clips that may be utilized. In another embodiment, the grounding clip 304 is simply a ground wire that is wrapped around, soldered, and/or otherwise attached to a portion of the clamping apparatus 300, for example.

In yet another embodiment, the grounding clip 304 may not serve to necessarily ground the clamping apparatus 300, but rather to add support to the clamping apparatus 300 and/or a portion thereof. For example, as will be evident from FIG. 6, the grounding clip 304 (e.g., which may be a metal washer) may reside between the rail and the spacer 306 (e.g., which may be comprised of a compressible material) and may be configured to support the spacer 306 against the rail (e.g., such that the weight of the spacer 306, clamp 308, and/or nut 310 is dispersed across the (rigid) grounding clip as opposed to the (compressible) spacer (e.g., which could potentially collapse into the channel of the rail)). Thus, in some embodiments, the grounding clip 304 may not necessarily be configured to (e.g., limited to) electrically ground the clamping apparatus 300, for example.

Still, in some other embodiments, the grounding clip 304 may be optional. For example, in some embodiments, the spacer 306 may be sufficiently sized to support weight of the spacer 306, clamp 308, and/or nut 310 across the channel and/or may be comprised of a material that is rigid enough to support the weight without collapsing into the channel. Moreover, in other embodiments, the spacer 306 may fit into the channel and remain in contact with the head of the bolt 302 once the clamping apparatus 300 is inserted into the channel (e.g., such that support of weight by spacer 306 is less important).

The clamping apparatus 300 further comprises the spacer 306 configured to be selectively coupled to the shaft of the bolt 302 and/or permanently affixed to the bolt 302. It will be appreciated that while the spacer is generally illustrated as having a concentric arrangement relative to the bolt 302, the instant disclosure, included the scope of the appended claims, is not intended to be so limited. That is, unless specified to the contrary, any configuration(s), design(s), etc. are contemplated for the spacer (e.g., that facilitate the functions provided herein). The spacer 306 is also configured to position the clamp 308 of the clamping apparatus 300 a specified distance from the first end (e.g., head 312) of the bolt 302 and/or to position the clamp 308 a specified distance from (e.g., a top edge of) the rail once the clamping apparatus 300 is attached to the rail, for example.

The spacer 306 is typically comprised of a compressible material and is configured to be compressed once the photovoltaic module is positioned appropriately relative to the rail to secure the module. That is, once the module is in the desired position, an installer, for example, may tighten the nut 310, causing the spacer 306 to be compressed and reducing the space between the rail and the clamp 308. Such compressible materials may comprise, but are not limited to, a spring (e.g., such as a rubber spring or metal spring), a polystyrene, and/or a compressible metal structure (e.g., such as a soft metal).

The clamping apparatus 300 also comprises a clamp 308 configured to be selectively coupled to the shaft of the bolt 302 and/or permanently affixed to the bolt 302. The clamp 308 is also configured to secure one or more photovoltaic modules to the rail. For example, the clamp 308 may comprise one or more edges that are configured to extend over a portion of the module(s). When the nut 310 is selectively coupled to the shaft via the second end of the bolt and tightened, the one or more edges extending over the portion of the module may apply pressure to the module, causing the module to be secured to the rail. In this way, the nut 310 acts to secure the clamp 308 and the spacer 306 to the bolt 302 and/or to apply pressure to the clamp 308 and/or the spacer 306 when tightened, for example.

The clamping apparatus 300 may also comprise other features that promote safely securing the one or more modules to the rail, for example. By way of example, in one embodiment, the clamp 308 comprises one or more tabs 314 that are configured to contact a side-edge of one or more modules (e.g., as opposed to a top edge facing the sunlight) and/or to be partially inserted between two or more modules. Such tabs 314 are configured to reduce and/or mitigate rotation of the clamp relative to the module while the nut 310 is being tightened, for example.

Moreover, as illustrated in FIGS. 4-5 (e.g., illustrating top-down views of the bolt 302 and the clamp 308, respectively) the shaft of the bolt 302 may comprise a non-cylindrical portion (e.g., such as a flat/shaved edge) and the clamp 308 may comprise a non-cylindrical aperture 316 (e.g., of a similar shape to the non-cylindrical portion of the shaft) into which the non-cylindrical portion of the shaft is inserted. Such non-cylindrical features of the bolt 302 and the clamp 308 and/or the tabs 314 of the clamp may mitigate rotation of the bolt 302, and the clamping apparatus 300 generally, relative to the rail once the bolt is inserted into the channel and turned appropriately (e.g., mitigating rotation of the bolt 302 as the nut 310 is being tightened). That is, stated differently, the one or more tabs 314, the non-cylindrically shaped aperture 316, and the non-cylindrically shaped portion of the bolt 302 may facilitate alignment of the first end of the bolt 302 (e.g., the head 312) within a channel of the rail, such that rotation of the bolt 302 relative to the channel is mitigated as the one or more modules are being secured (e.g., as the nut 310 is being tightened).

It will be appreciated that these and other features may be described in more detail in U.S. Patent Publication 2011/0299957 and assigned to Preformed Line Products Company, at least some of which may be incorporated herein by reference. For example, another feature of the bolt 302 may be that one or more edges of the head 312 of the bolt 302 are rounded while other edges are substantially square to control how the bolt 302 can be rotated within the channel of the rail. For example, in one embodiment, the head 312 comprises one round corner and three square corners such that the bolt can be rotated in merely one direction relative to the rail when the t-shaped head of the bolt is inserted into a channel of the rail (e.g., because the square corners limit rotation in other directions). Moreover, once turned to a specified position (e.g., turned 90 degrees relative to an initial position when the bolt/clamping apparatus is inserted into the channel (e.g., such that the head is substantially perpendicular to the channel as described further in FIGS. 7-8), the head 312 with merely one round corner may mitigate further rotation of the bolt 302 (e.g., to mitigate rotating the bolt further such that the head 312 becomes parallel with the channel).

FIG. 6 illustrates a cross-sectional view (e.g., taken along line 6-6 in FIG. 1) illustrating a clamping apparatus 600 (e.g., 300 in FIG. 3) securing a photovoltaic module 602 (e.g., 102 in FIG. 1) to a rail 604 (e.g., 104 in FIG. 1) via a channel 606 (e.g., 206 in FIG. 2). The clamping apparatus 600 comprises a bolt 608 (e.g., 302 in FIG. 3) comprising a head 610 (e.g., 312 in FIG. 3) that is inserted into the channel 606 of the rail 604. The example clamping apparatus 600 also comprises a grounding clip 612 (e.g., 304 in FIG. 3), spacer 614 (e.g., 306 in FIG. 3), clamp 616 (e.g., 308 in FIG. 3) (e.g., including tabs 620 (e.g., 314 in FIG. 3) that abut the side of the module 602), and a nut 618 (e.g., 310 in FIG. 3).

FIG. 7-8 illustrate how a preassembled clamping apparatus 700 (e.g., 600 in FIG. 6) comprising a bolt 702 (e.g., 302 in FIG. 3) having a t-shaped head 704 (e.g., 312 in FIG. 3) may be selectively coupled to a rail 706 (e.g., 204 in FIG. 2). More particularly, FIG. 7 illustrates a portion of the clamping apparatus 700 being inserted into a channel 708 (e.g., 206 in FIG. 2) of the rail 706. The t-shaped head 704 is turned such that a more narrow dimension 710 of the head 704 is perpendicular the length of the channel 708 (e.g., going into and out of the page), allowing the t-shaped head 704 to be lowered into the channel 708.

Once the t-shaped head 704 is positioned in the channel 708, the bolt 702 (e.g., and/or the entire clamping apparatus 700) may be rotated 712 clockwise and/or counter-clockwise (e.g., 90 degrees) until the narrow dimension of the head 704 is parallel or substantially parallel to the length of the channel 708 (e.g., such that the narrow dimension of the head 704 is going into and/or out of the page) as illustrated in FIG. 8. It will be appreciated that this changed orientation of the head 704 relative to the channel 708 can reduce (e.g., mitigate) the possibility of the clamping apparatus 700 becoming unsecured from the rail 706.

FIG. 9 illustrates an example method 900 which may be utilized to preassemble a rail (e.g., to which a photovoltaic module attaches) for shipment to an installation site, for example. The example method 900 begins at 902, and a rail configured to secure one or more photovoltaic modules is preassembled at 904. Preassembling the rail typical comprises, among other things, coupling a clamping apparatus to the rail at 906. The clamping apparatus is generally configured similar to the clamping apparatus illustrated in FIG. 3 and comprises, among other things a bolt, a clamp, and a spacer. As previously described, the spacer is configured to position the clamp a specified distance from the head of the bolt and/or a specified distance from an edge of the rail into which a portion of the bolt is inserted.

The clamping apparatus may be assembled prior to coupling it to the rail and/or it may be assembled as part of the act of coupling the clamping apparatus to the rail. For example, in one embodiment, the clamping apparatus is preassembled such that the bolt, spacer, and clamp are coupled together (e.g., fastened together) prior to the clamping apparatus being coupled to the rail (e.g., in a factory and/or at an installation site). In this way, the clamping apparatus is one unit prior to assembly with the rail. However, in another embodiment, coupling the clamping apparatus to the rail may comprise assembling the clamping apparatus on the rail. For example, a first end of the bolt may be inserted into a channel of the rail, and the rail may be positioned/oriented as desired. Subsequently, the spacer may be associated with the bolt (e.g., via an aperture of the spacer (e.g., such that the spacer is positioned between the rail and a second end of the bolt)), a clamp may be placed onto the bolt via an aperture of the clamp, and a nut may be secured to the bolt to hold the spacer and clamp in place.

Typically, the spacer is configured to maintain a relative orientation of the clamping apparatus and the rail (e.g., such that angle between the clamping apparatus and a top edge of the rail is substantially ninety degrees). Moreover, in one embodiment, the spacer may be slightly compressed as part of the preassembly such that a degree of pressure is applied to the rail. Such pressure may further assist in maintaining a position of the clamping apparatus relative to the rail (e.g., such that the clamping apparatus does not slide along the channel). Thus, the spacer may be utilized to reduce slippage of the clamping apparatus when (an edge of) a module is positioned between the rail and the clamp of the clamping apparatus, for example.

As described above, in some embodiments, the clamp and/or the bolt may comprise features that further aid in the installation of the photovoltaic modules and/or in securing the photovoltaic module(s) to the rail. For example, in one embodiment, the bolt may comprise a shaft having a non-cylindrical portion and the clamp may comprise a corresponding (e.g., similarly shaped), non-cylindrical aperture through which the non-cylindrical portion of the bolt can be inserted. In this way, rotation of the bolt relative to the clamp is reduced (e.g., to reduce the possibility of the bolt being turned in such a manner that it can slip and/or rotate out of the channel). Moreover, the clamp may comprise tabs that abut a side-edge of the photovoltaic modules to further reduce the possibility of the clamp rotating.

Once the rail is preassembled at 904 (e.g., which includes coupling the clamping apparatus to the rail at 906), the preassembled rail may be shipped for assembly at 908. In this way, the rail may be shipped from the factory with the clamping apparatuses preinstalled at specified locations to reduce installation time on site, for example. To complete the installation onsite, the installer therefore merely attaches the rails to an installation site (e.g., a roof) inserts one or more modules into the space between the top edge of the rail and the clamp (e.g., as established by the spacer), secures the module by tightening a nut of the respective clamping apparatuses (e.g., already installed on the rail), and connects wiring of photovoltaic module(s) to a power grid and/or power consumption device, for example.

The example method 900 ends at 910.

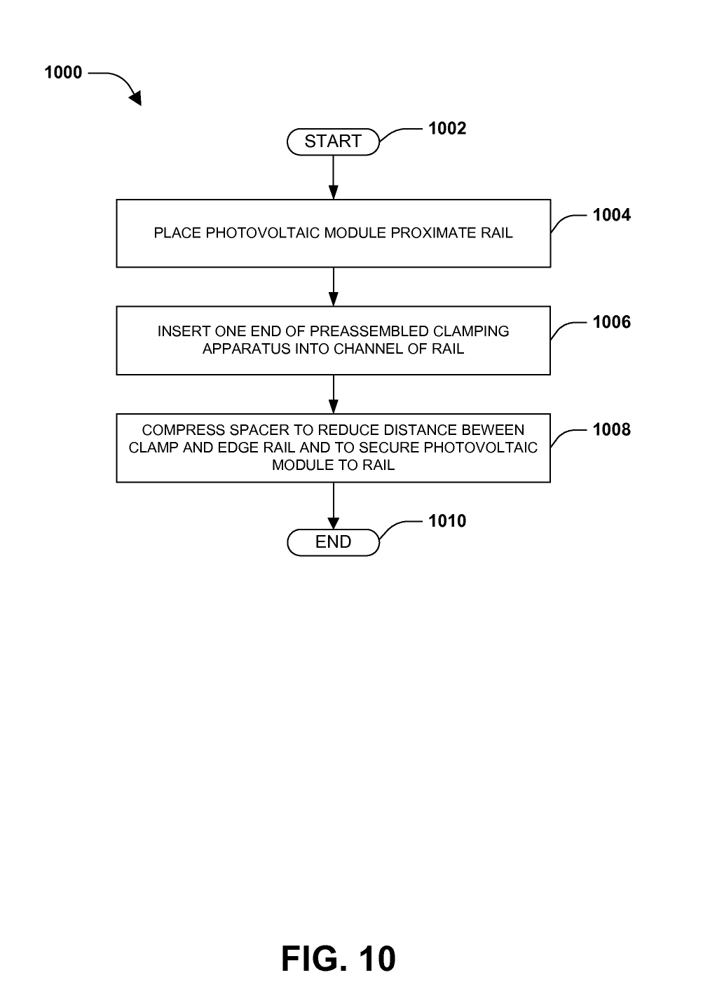

FIG. 10 illustrates a method 1000 for securing a photovoltaic module to a rail when the rail is not preassembled as provided for in the example method 900 of FIG. 9. By way of example, FIG. 10 provides for a method 1000 where the clamping apparatus is attached to the rail at the installation site (e.g., as opposed to being attached to the rail at factory prior to shipment of the rails).

The example method 1000 begins at 1002, and a photovoltaic module is placed proximate the rail at 1004. Generally, a diagram provided by the photovoltaic array manufacturer describes how the photovoltaic modules are to be arranged and an installer, for example, may place the modules on the rails accordingly.

At 1006 in the example method 1000, one end of a preassembled clamping apparatus is inserted into a channel of the rail (e.g., before or after a photovoltaic module is placed proximate the rail). For example, as described above, the clamping apparatus may comprise a bolt having a t-shaped head that can be inserted into the channel and rotated (e.g., about 90 degrees) to lock or secure the clamping apparatus to the rail. Alternatively, in another embodiment, a portion of the clamping apparatus may be feed through an outer (e.g., ‘open’) edge of the channel and moved along the channel until it is located in a desired position.

As described with respect to FIG. 3, generally the clamping apparatus comprises, among other things, a bolt, a clamp, and a spacer. The spacer is configured to position the clamp a specified distance from a top edge of the rail and/or from a head of the bolt, for example. In this way, the module may be seated between the rail and the clamp with minimal (if any) adjusts to the clamping apparatus (e.g., besides tightening the nut to secure the module).

Preassembling of the clamping apparatus may occur at a factory and/or may occur at the installation site, for example. As an example, in one embodiment, the clamping apparatuses may be preassembled at the factory and shipped, preassembled, to the installation site, where the installers can attach them to the rails. In another embodiment, an installer may assemble the clamping apparatuses at the installation site, prior to the clamping apparatuses being coupled to the rail, for example.

It will be appreciated that while the example method 1000 illustrates the placement of the photovoltaic modules proximate the rail prior to the insertion of the preassembled clamping apparatus into a channel of the rail, such actions may be reversed. For example, given a diagram describing the arrangement of the modules (e.g., and clamping apparatuses), the installer may begin by attaching the clamping apparatuses to the rail and may proceed to place or slide the photovoltaic modules into place once the clamping apparatus(es) are attached/affixed to the rail.

At 1008, the spacer of the clamping apparatus is compressed to reduce the distance between the clamp and the top edge of the rail and/or the distance between the clamp and the head of the bolt. By way of example, a nut or other fastener of the clamping apparatus may be tightened to apply pressure to the spacer, causing it to compress. The applied pressure also typically causes the clamp to apply pressure on the module, causing the module to be secured to the rail by way of the clamping apparatus.

At 1010, the example method 1000 ends.

It may be appreciated that the words “example” and/or “exemplary” are used herein to mean serving as an example, instance, or illustration. Any aspect, design, etc. described herein as “example” and/or “exemplary” is not necessarily to be construed as advantageous over other aspects, designs, etc. Rather, use of these terms is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B or the like generally means A or B or both A and B.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. Similarly, illustrated ordering(s) of acts is not meant to be limiting, such that different orderings comprising the same of different (e.g., numbers) of acts are intended to fall within the scope of the instant disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A clamping apparatus configured to secure one or more photovoltaic modules to a rail, comprising:
a bolt comprising a shaft, the bolt comprising a first end and a second end;
a clamp configured to secure the one or more photovoltaic modules to the rail, the clamp configured to be selectively coupled to the shaft; and
a spacer configured to position the clamp a specified distance from the first end of the bolt.

2. The apparatus of claim 1, the first end of the bolt comprising a t-shaped head configured to be inserted into a channel of the rail.

3. The apparatus of claim 1, the shaft comprising a non-cylindrical portion and the clamp comprising a non-cylindrically shaped aperture, the aperture substantially similar in shape to the non-cylindrical portion of the shaft.

4. The apparatus of claim 3, the clamp comprising one or more tabs, the one or more tabs and the non-cylindrically shaped aperture facilitating an alignment of the first end of the bolt within a channel of the rail, such that rotation of the bolt relative to the channel is mitigated once the clamp secures the one or more photovoltaic modules.

5. The apparatus claim 1, the clamp comprising one or more tabs configured to be at least partially inserted between two or more photovoltaic modules.

6. The apparatus of claim 1, comprising a nut configured to be selectively coupled to the shaft via the second end and to secure the clamp and the spacer to the bolt.

7. The apparatus of claim 6, the clamp, the spacer, and the nut selectively coupled to the shaft to preassemble the clamping apparatus prior to attachment of the clamping apparatus to the rail.

8. The apparatus of claim 1, the spacer comprised of a compressible material.

9. The apparatus of claim 1, the spacer comprised of a spring.

10. The apparatus of claim 1, the spacer comprised of polystyrene.

11. The apparatus of claim 1, the spacer comprised of a compressible metal structure.

12. The apparatus of claim 1, comprising a grounding clip configured to ground the clamping apparatus.

13. The apparatus of claim 12, the grounding clip comprising a washer.

14. A method, comprising:
preassembling a rail configured to secure one or more photovoltaic modules, comprising:
coupling a clamping apparatus to the rail, the clamping apparatus configured to secure the one or more photovoltaic modules to the preassembled rail, the clamping apparatus comprising a bolt, a clamp, and a spacer, the spacer configured to position the clamp a specified distance from an edge of the rail to which the bolt is inserted.

15. The method of claim 14, comprising shipping the preassembled rail for assembly with the one or more photovoltaic modules.

16. The method of claim 14, comprising inserting the one or more photovoltaic modules into a space, at least partially defined by the spacer, between the edge of the rail and the clamp.

17. The method of claim 16, comprising securing the one or more photovoltaic modules to the rail by compressing the spacer such that the space between the edge of the rail and the clamp is reduced.

18. The method of claim 14, coupling the clamping apparatus to the rail, comprising:
inserting a first end of a bolt into a channel of the rail, where the spacer facilitates maintaining an orientation of the bolt relative to the rail.

19. The method of claim 18, coupling the clamping apparatus to the rail, comprising:
placing the spacer onto the bolt via an aperture of the spacer, the spacer positioned between the rail and a second end of the bolt; and
placing the clamp onto the bolt via an aperture of the clamp, the spacer positioned between the rail and the clamp.

20. The method of claim 19, the bolt comprising a shaft having a non-cylindrical portion and the clamp configured to be inserted onto the bolt via a non-cylindrical aperture of the clamp that substantially corresponds to the non-cylindrical portion of the shaft.

21. The method of claim 14, comprising, prior to coupling the clamping apparatus to the rail, assembling the coupling apparatus, assembling the coupling apparatus comprising:
inserting a shaft of the bolt through a corresponding aperture of the spacer; and
inserting a non-cylindrical portion of the shaft through a non-cylindrical aperture of the clamp, such that rotation of the clamp relative to the bolt is mitigated.

22. A clamping apparatus configured to secure one or more photovoltaic modules to a rail, comprising:
a bolt comprising a t-shaped head and a shaft;
a clamp configured to secure the one or more photovoltaic modules to the rail, the clamp configured to be selectively coupled to the shaft; and
a compressible spacer configured to be selectively coupled to the shaft and to position the clamp a specified distance from the head of the bolt.

23. The apparatus of claim 22, the shaft comprising a non-cylindrical portion and the clamp comprising a non-cylindrical aperture through which the non-cylindrical portion of the shaft is passed, the non-cylindrical aperture having a shape that substantially corresponds to a shape of the non-cylindrical portion of the shaft.

24. The apparatus of claim 22, the t-shaped head comprising a rounded corner and three substantially square corners such that the bolt can be rotated in merely one direction relative to the rail when the t-shaped head of the bolt is inserted into a channel of the rail.

25. A method for securing a photovoltaic module to a rail, comprising:
placing the photovoltaic module proximate the rail;
inserting one end of a preassembled clamping apparatus into a channel of the rail, the preassembled clamping apparatus comprising at least a bolt, a clamp, and a spacer, the spacer configured to position the clamp a specified distance from an edge of the rail; and
compressing the spacer to reduce the distance between the clamp and the edge of the rail and to secure the photovoltaic module to the rail.

26. The method of claim 25, comprising rotating the bolt to lock the bolt into the channel of the rail.

27. The method of claim 25, comprising inserting one or more tabs of the clamp adjacent the photovoltaic module to mitigate rotation of the clamp relative to the photovoltaic module.

28. The method of claim 27, the bolt comprising a shaft having a non-cylindrical portion, and the clamp having a corresponding non-cylindrical aperture through which the non-cylindrical portion of the shaft is inserted, and inserting one or more tabs of the clamp adjacent the photovoltaic module comprising inserting one or more tabs of the clamp adjacent the photovoltaic module to mitigate rotation of the bolt relative to the rail while the spacer is being compressed.
